(19) United States
(12) Patent Application Publication
(10) Pub. No.: US 2008/0131672 A1
(43) Pub. Date: Jun. 5, 2008

(54) Metallized multilayer film

(76) Inventors: Siaw Teck Sang, Melaka (MY); Yves Ledu, Valailles (FR); Patrice Robert, Serquigny (FR)

Correspondence Address: MILLEN, WHITE, ZELANO & BRANIGAN, P.C.;Arlington Courthouse Plaza 1, Suite 1400, 2200 Clarendon Boulevard, Arlington, VA, 22201, US

(21) Appl. No.: 10/773,451

(22) Filed: Feb. 9, 2004

(30) Foreign Application Priority Data
Feb. 7, 2003 (FR) 0301458

(51) Int. Cl. B32B 7/12; B32B 15/04; C08L 51/00

(52) U.S. Cl. 428/209; 428/457; 525/70

(57) ABSTRACT

The subject of the invention is a metallized film produced using a multilayer structure comprising a tie layer comprising:
5 to 50% by weight of a blend (A) comprising:
   5 to 100% of a cografted blend of polymers (C1) and (C2), consisting of 90 to 20% by weight of a metallocene polyethylene (C1) of density between 0.865 and 0.915 and of 10 to 80% by weight of a polymer (C2) which is either a non-metallocene LLDPE or a polypropylene homopolymer or copolymer, and
   95 to 0% by weight of a polyethylene (D) chosen from polyethylene homopolymers or copolymers and elastomers;
the blend (A) being such that:
   the content of grafting monomer grafted is between 30 and 10⁵ ppm;
   the MFI or meltflow index (ASTM D 1238, at 190° C./2.16 kg) is between 0.1 and 30 g/10 min;
50 to 95% by weight of a polypropylene homopolymer or copolymer (B).

The present invention relates to the field of packaging using, in particular, biaxially oriented or unoriented multilayer films metallized and laminated with a biaxially oriented polypropylene (BOPP) film or biaxially oriented polyethylene terephthalate (BOPET) film, which is printed or not printed, exhibiting very good adhesion of the layers to each other even when the films are weakened by a weld. The invention applies inter alia to packages of a sachet, bag, pouch or packet type, produced from these welded films, the composition of which allows the package to be correctly opened manually. Non-limiting mention may be made, for example, of packets of crisps, biscuits, sweets or meat.

Document WO 01/34389 discloses a package using a multilayer film having oxygen and water-vapour barrier properties, but this package has the drawback when it is desired to open it of not opening cleanly. This is because there is delamination between the metal layer and the polypropylene layer on which the metal layer is deposited.

It is important in the field of packaging to have packages that open cleanly in exerting a moderate force, so that they can be opened both by an adult and by a child. In addition, it is necessary for the films making up the packages to have oxygen and water-vapour barrier properties so as to preserve the foodstuffs, whether solid or liquid, edible or otherwise, laying inside the package.

The Applicant has now found a film that exhibits strong adhesion between a metal layer and a layer having a composition based (i) predominantly on polypropylene and (ii) to a minor extent on a blend either of cografted polyethylenes (abbreviated to g-PE) or of cografted polyethylene and polypropylene, and (iii) optionally of ungrafted polyethylene or elastomer. This film makes it possible inter alia to manufacture packages closed by a band of welding of the said film, the opening taking place within this same band. Unlike the prior art, there is no preferential delamination or peeling between the metal and PP layers to the detriment of the opening of the package within the welding band. This is because the package according to the invention opens cleanly within the welding band without there being any damage to the multilayer structure elsewhere.

The subject of the invention is a tie layer comprising:

5 to 50% by weight of a blend (A), the said blend (A) comprising:
5 to 100% of a blend of polymers (C1) and (C2), consisting of 90 to 20% by weight of a metallocene polyethylene (C1) of density between 0.865 and 0.915 and of 10 to 80% by weight of a polymer (C2) which is either a non-metallocene LLDPE or a polypropylene homopolymer or copolymer, the blend of polymers (C1) and (C2) being cografted by an unsaturated carboxylic acid or a functional derivative of this acid as grafting monomer, and
95 to 0% by weight of a polyethylene (D) chosen from polyethylene homopolymers or copolymers and elastomers;

the blend (A) being such that:
the content of grafting monomer grafted is between 30 and 10⁵ ppm;
the MFI or meltflow index (ASTM D 1238, at 190° C./2.16 kg) is between 0.1 and 30 g/10 min;
50 to 95% by weight of a polypropylene homopolymer or copolymer (B).

The invention also relates to a multilayer structure comprising a tie layer as defined above.

According to one embodiment, the multilayer structure comprises a metal layer bonded to the tie layer.

According to one embodiment, the structure is precharacterized in that the metal layer is a layer of Al, Fe, Cu, Sn, Ni, Ag, Cr or Au or an alloy containing predominantly at least one of these metals.

According to one embodiment, the multilayer structure is characterized in that it comprises a polypropylene homopolymer or copolymer layer (3), the tie layer (2) being sandwiched between the metal layer (1) and the said polypropylene layer (3).

According to one embodiment, the multilayer is characterized in that it comprises a layer suitable for heat-seating and comprising either an ethylene/propylene/butylene terpolymer, or an ethylene/propylene copolymer, or a metallocene PE or blends thereof, and in this case the said blend comprises at least two of the abovementioned compounds, the polypropylene layer being sandwiched between the tie layer and the said layer suitable for heat-sealing.

The invention also relates to a film comprising a multilayer structure as defined above.

According to one embodiment, the film is characterized in that it comprises a printed biaxially oriented polypropylene (BOPP) or biaxially oriented polyethylene terephthalate (BOPET) layer to which a metallized multilayer film having a structure as described above is applied by means of an adhesive, the said film being biaxially oriented or not and the metal layer of the said metallized multilayer film being directly bonded by the adhesive to the printed BOPP or BOPET layer.

The invention also relates to the use at a tie for manufacturing a multilayer structure as defined above.

The invention also relates to an article having a multilayer structure as described above.

According to one embodiment, the article is manufactured with a film as described above.

According to one embodiment, the article is a package.

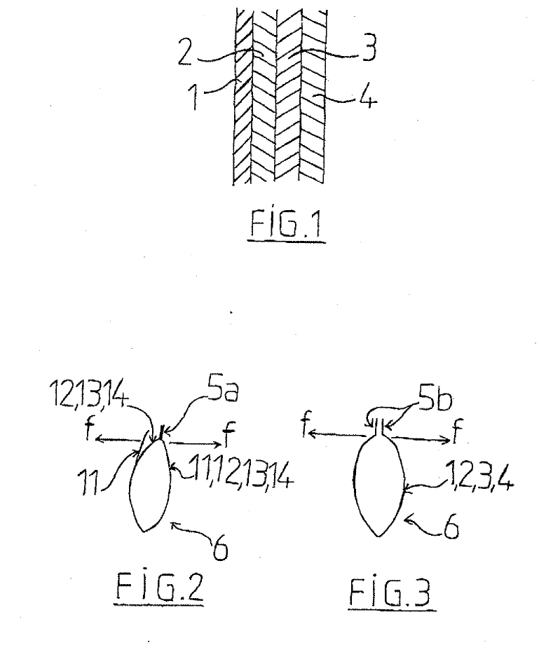

FIG. 1 shows one embodiment of a film according to the invention, the said metallized cast polypropylene (MCPP) film having a structure with layers 1 to 4 coming one after another in the following order: a layer (1) of metal, a layer (2) of a blend of cografted PE and LLDPE, of LLDPE and of PP homopolymer or copolymer, a layer (3) of PP homopolymer or copolymer and a layer (4) of polymer suitable for heat seating.

FIG. 2 shows in cross section a bag (6) closed by a welding band (5a), according to the abovementioned prior art, after a failed attempt at opening it, the said bag being produced using a film having the following structure: a layer (11) of metal, a layer (12) of a blend of syndiotactic PP and of a butylene/propylene copolymer or of a blend of syndiotactic PP and of grafted PP homopolymer or copolymer, a layer (13) of PP homopolymer or copolymer, and a layer (14) of ethylene/propylene/butylene terpolymer or ethylene/propylene copolymer or metallocene PE.

FIG. 3 shows in cross section a bag according to the invention after it has been opened within the welding band, the opening being defined by the edges (5b) and the bag (6) being produced using the film having a multilayer structure (layers 1-4) shown in FIG. 1.

We will now describe the invention in further detail. The packages—the articles of the invention—comprise a film made of metallized cast PP (MCPP for short). This film may form part of a structure of the type: BOPP or BOPET layer/ink layer/adhesive layer/MCPP film.

The MCPP film has a multilayer structure shown in FIG. 1 and having the following form: layer (1)/layer (2)/layer (3)/layer (4), the composition of which will be given below.

Within an MCPP film there are therefore the following layers, coming one after another in the order: BOPP or BOPET layer/ink layer/adhesive layer/layer (1)/layer (2)/layer (3)/layer (4).

The layer (1) is a metal layer applied to a layer (2). It may, for example, be a foil or film of a metal such as Al, Fe, Cu, Sn, Ni, Ag, Cr, Au or an alloy containing predominantly at least one of these metals.

The layer (3) is a PP layer. The polypropylene of the layer (3) may be a homopolymer or a copolymer.

As comonomers, mention may be made of:
α-olefins, advantageously those having from 2 to 30 carbon atoms, such as ethylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicocene, 1-dococene, 1-tetracocene, 1-hexacocene, 1-octacocene and 1-triacontene. These α-olefins may be used by themselves or as a blend of two or more of them;
dienes.

### The polypropylene may also be a polypropylene block copolymer.

Advantageously, the layer (3) comprises a blend of several polymers, in which there is at least one polypropylene comprising at least 50 mol % and preferably at least 75 mol % of propylene. As an example, the polypropylene of the layer (3) may be a polypropylene/EPDM or polypropylene/EPR blend.

As PP homopolymer, mention may be made of between 80 and 100%, preferably 95% isotactic PP. The polypropylene homopolymer preferably has an MFI (melt flow index) of between 1.2 and 30 g/10 min, preferably between 3 and 8 g/10 min, measured according to ASTM D1238.

The layer (4) is a layer suitable for heat sealing. It may comprise, for example, an ethylene/propylene/butylene terpolymer, an ethylene/propylene copolymer, a metallocene PE or blends thereof (blend of at least two of the abovementioned compounds). Advantageously, the layer (4) comprises a terpolymer comprising predominantly propylene as comonomer.

The layer (2) is produced using a blend comprising:

5 to 50%, preferably 20 to 40%, by weight of a blend of (A); and

50 to 95%, preferably 60 to 80%, by weight of a polymer (B).

With regard to the blend (A) defined by a blend (C) optionally blended with a polymer (D), this comprises:

5 to 100% by weight (with respect to the blend (A)) of the blend (a), which itself consists of a blend of 80 to 20% by weight (with respect to the blend (C)) of a metallocene polyethylene (C1) of density between 0.865 and 0.915 and of 20 to 80% by weight (with respect to the blend (C)) of a non-metallocene LLDPE (C2), the blend of polymers (C1) and (C2) being cografted by an unsaturated carboxylic acid or a functional derivative of this acid as grafting monomer; and

95 to 0% by weight (with respect to blend (A)) of a polyethylene (D) chosen from polyethylene homopolymers or copolymers and elastomers;

the blend (A) being such that:

the content of grafting monomer grafted is between 30 and 10⁵ ppm;

the MFI or meltflow index (ASTM D 1238, at 190° C./2.16 kg is between 0.1 and 30 g/10 min;

With regard to polymer (C1), “metallocene polyethylene” should be understood to mean polymers obtained by the copolymerization of ethylene with an α-olefin such as, for example, propylene, butene, hexene or octene in the presence of a monosite catalyst generally consisting of an atom of a metal, which may for example be zirconium or titanium, and of two alkyl cyclic molecules linked to the metal. More specifically, the metallocene catalysts are usually composed of two cyclopentadiene rings linked to the metal. These catalysts are frequently used with aluminoxanes as cocatalysts or activators, preferably methylaluminoxane (MAO). Hafnium may also be used as the metal to which the cyclopentadiene is attached. Other metallocenes may include transition metals of Groups IVA, VA and VIA. Metals of the lanthanide series may also be used.

These metallocene polyethylenes may also be characterized by their M_{w}/Mₙ ratio<3 and preferably <2 in which M_{w} and Mₙ denote the weight-average molecular mass and the number-average molecular mass, respectively. The term “metallocene polyethylene” also denotes those having an MFR (Melt Flow Ratio))<6.53 and an M_{w}/Mₙ ratio>(MFR−4.63). MFR denotes the ratio of the MFI₁₀ (MFI under a load of 10 kg) to the MFI₂ (MFI under a load of 2.16 kg). Other metallocene polyethylenes are defined by an MFR equal to or greater than 6.13 and an M_{w}/Mₙ ratio less than or equal to (MFR−4.63).

Advantageously, the density of (C1) is between 0.870 et 0.900.

With regard to polymer (C2), this is either an ethylene/α-olefin copolymer of the LLDPE (linear low-density polyethylene type) which is not of metallocene origin, or a polypropylene homopolymer or copolymer with, as comonomers, for example α-olefins or dienes. The polymer (C2) may also be a polypropylene block copolymer.

The α-olefins advantageously have 3 to 30 carbon atoms.

Examples of α-olefins having 3 to 30 carbon atoms comprise ethylene (only comonomers of the PP), propylene (only comonomer of the PE), 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicocene, 1-dococene, 1-tetracocene, 1-hexacocene, 1-octacocene and 1-triacontene. These α-olefins may be used by themselves or as a blend of two or more of them.

The density of (C2) is advantageously between 0-900 and 0.950. The MFI of (C2) is between 0.1 and 8 g/10 min (at 190° C./2.16 kg).

The (C1)/(C2) blend is grafted by a grafting monomer taken from the group of unsaturated carboxylic acids or their functional derivatives. Examples of unsaturated carboxylic acids are those having 2 to 20 carbon atoms, such as acrylic, methacrylic, maleic, fumaric and itaconic acids. The functional derivatives of these acids comprise, for example, anhydrides, ester derivatives, amide derivatives, imide derivatives and metal salts (such as alkali metal salts) of unsaturated carboxylic acids.

Unsaturated dicarboxylic acids having 4 to 10 carbon atoms and their functional derivatives, particularly their anhydrides, are particularly preferred grafting monomers.

These grafting monomers comprise, for example, maleic, fumaric, itaconic, citraconic, allylsuccinic, cyclohax-4-ene-1,2-dicarboxylic, 4-methylcyclohex-4-ene-1,2-dicarboxylic, bicyclo[2.2.1]hept-5-ene-2,3-dicarboxylic and x-methylbicyclo[2.2.1]hept-5-ene-2,2-dicarboxylic acids and maleic, itaconic, citraconic, allylsuccinic, cyclohex-4-ene-1,2-dicarboxylic, 4-methylenecyclohex-4-ene-1,2-dicarboxylic, bicyclo-[2.2.1]hept-5-ene-2,3-dicarboxylic and x-methyl-bicyclo[2.2.1]hept-5-ene-2,2-dicarboxylic anhydrides.

Examples of other grafting monomers comprise:
C₁-C₈ alkyl esters or glycidyl ester derivatives of unsaturated carboxylic acids, such as methyl acrylate, methyl methacrylate, ethyl acrylate, ethyl methacrylate, butyl acrylate, butyl methacrylate, glycidyl acrylate, glycidyl methacrylate, monoethyl maleate, diethyl maleate, monoethyl fumarate, dimethyl fumarate, monomethyl itaconate and diethyl itaconate;
amide derivatives of unsaturated carboxylic acids, such as acrylamide, methacrylamide, the monoamide of maleic acid, the diamide of maleic acid, the N-monoethylamide of maleic acid, the N,N-diethylamide of maleic acid, the N-monobutylamide of maleic acid, the N,N-dibutylamide of maleic acid, the monoamide of fumaric acid, the diamide of fumaric acid, the N-mono-ethylamide of fumaric acid, the N,N-diethylamide of fumaric acid, the N-monobutylamide of fumaric acid and the N,N-dibutylamide of fumaric acid;
imide derivatives of unsaturated carboxylic acids, such as maleimide, N-butylmaleimide, N-phenylmaleimide; and
metal salts of unsaturated carboxylic acids, such as sodium acrylate, sodium methacrylate, potassium acrylate and potassium methacrylate. Maleic anhydride is preferred.

Various known processes may be used to graft a grating monomer onto the blend of (C1) and (C2).

The amount of grating monomer is chosen in an appropriate manner, and is between 0.01 and 10%, preferably between 600 ppm and 5000 ppm with respect to the weight of grafted (C1) and (C2). The amount of grafted monomer is determined by assaying the succinic functional groups by FTIR spectroscopy. The MFI of (a), that is to say of (C1) and (C2) which have been cografted, is 0.1 to 10 g/10 min.

With regard to polyethylene (D), this is a polyethylene homopolymer or an ethylene copolymer with, as comonomer, a monomer chosen from the α-olefins defined above in the case of (C2), esters of unsaturated carboxylic acids or vinylesters of saturated carboxylic acids. The unsaturated carboxylic acid esters are, for example, alkyl (meth)acrylates, the alkyl of which has 1 to 24 carbon atoms. Examples of alkyl acrylates or methacrylates are especially methyl methacrylate, ethyl acylate, n-butyl acrylate, isobutyl acrylate and 2-ethylhexyl acrylate. Saturated carboxylic acid vinylesters are, for example, vinyl acetate or vinyl propionate.

The polyethylene (D) may be a high-density PE (HOPE), a low-density PE (LDPE), a linear low-density PE (LLDPE), a very low-density PE (VLDPE) or a metallocene PE.

The polyethylene (D) may also be a polymer having an elastomeric character, that is to say it may be (i) an elastomer within the meaning of ASTM D412, which means a material that can be stretched at room temperature to twice its length, held thus stretched for 5 minutes and then returning to a length that is less than 10% different from its initial length after having been released, or (ii) a polymer not having exactly the above characteristics but able to be stretched and returning approximately to its initial length. As examples, mention may be made of:
EPR (ethylene-propylene rubber) and EPDM (ethylene propylene diene monomer); and
styrene elastomers, such as SBR (styrene/butadiene/rubber), SOS (styrene/butadiene/styrene) block copolymers, SEBS (styrene/ethylene-butadiene/styrene) block copolymers and SIS (styrene/isoprene/styrene) block copolymers.

Advantageously, the polyethylene (D) is an LLDPE having a density of between 0.900 and 0.935 or else an HOPE having a density of between 0.935 and 0.950.

Advantageously the proportions in the blend (A) of polymers (C) and (D) are 10 to 30% by weight of (C) per 90 to 70% by weight of (D), respectively.

With regard to the polymer (B), in which the blend (A) is diluted, this is a PP copolymer or propylene/ethylene/butylene terpolymer. As comonomer, mention may be made of:
α-olefins, advantageously those having from 2 to 30 carbon atoms, such as ethylene, 1-butene, 1-pentene, 3-methyl-1-butene, 1-hexene, 4-methyl-1-pentene, 3-methyl-1-pentene, 1-octene, 1-decene, 1-dodecene, is 1-tetradecene, 1-hexadecene, 1-octadecene, 1-eicocene, 1-dococene, 1-tetracocene, 1-hexacocene, 1-octacocene and 1-triacontene. These α-olefins may be used by themselves or as a blend of two or more of them;
dienes.

### The polypropylene may also be a propylene block copolymer.

Advantageously, the polymer (B) comprises a blend of several polymers, in which there is at least one polypropylene containing at least 50 mol % and preferably at least 75 mol % polypropylene. As an example, the polymer (B) may be a polypropylene/EPDM or polypropylene/EPR blend.

The layers (1), (2), (3) and (4) may have a thickness of between 50 and 500 Angstroms in the case of the layer (1), between 2 and 6 μm in the case of the layer (2), between 5 and 30 μm in the case of the layer (3) and between 2 and 10 μm in the case of the layer (4).

The layers (2), (3) and (4) may be laminated together by a coextrusion process before the metal layer (1) is applied. As regards the layer (1), this may be applied by vapour deposition, using a technique well known to those skilled in the art, and is preferably deposited under vacuum.

The metal layer (1) constitutes a good oxygen and water-vapour barrier.

The compositions of the layers (2), (3) and (4) may contain the additives normally used for processing polyolefins, having contents of between 10 ppm and 5%, such as antioxidants based on substituted phenolic molecules, UV screens, processing aids, such as fatty amides, stearic acid and its salts, fluoropolymers, known as agents for avoiding extrusion defects, amine-based defogging agents, antiblocking agents, such as silica or talc, and masterbatches with dyes and nucleating agents.

FIGS. 2 and 3 clearly shown the result of the invention compared with the prior art. The bags shown in these figures are similar to crisp packets, comprising firstly a pocket bounded by a multilayer structure (11, 12, 13, 14) in the case of FIG. 2 and a multilayer structure (1, 2, 3, 4) in the case of FIG. 3, the metal layer (1) or (11) being in contact with the outside of the pocket, while the layer (4) or (14) is in contact with the inside of the pocket. The two bags or packets are closed by a welding strip (5a) of the multilayer film which constitutes them, the layer (4) or (14) of each welding edge (5b), defining the opening of the bags (6), being welded to itself. An identical force (f) is then applied to these two packets on each side of the region adjoining the welding bands (5a) so as to open the said packets. It has been found that, by exerting the same force (f) on each side of the packets in the directions indicated in the figures, different results are obtained depending on whether the packet is one produced using a film according to the prior art or a packet produced using a film according to the invention.

In the case of a bag or packet of FIG. 2, it is observed that there is delamination, that is to say separation, of the metallized layer (11) from the layers (12), (13) and (14), which remain bonded together. It may therefore be stated that the force to delaminate the layer (11) is less than the force needed to break the welding band (sa). As a result, the bag in this case is difficult to open, the metallized layer (11) debonding first.
In the case of FIG. 3, no debonding of the layers (1), (2), (3) and (4) is observed, rather a failure within the welding band of the bag, resulting in the packet being opened via the edges (5b). The adhesive strength of the metal layer (11) is much greater than the force needed to break the welding band (5a), causing the bag to be opened.

Film specimens 1 to 8 (see TABLE 1 below) were produced, these having a multilayer structure of the BOPP (approximately 20 μm)/ink layer/liquid adhesive layer/MCPP film (approximately 25 μm) type.

The MCPP film had a 4-layer structure, as shown in FIG. 1, namely:
Al layer (1) having a thickness of 250 ångstroms;
layer (2) having a thickness of 3 μm, comprising:
   X % by weight of a blend (A), which itself comprises 25% by weight of metallocene PE (C1) of density d=0.870 with 1-octene as comonomer and of LLDPE (C2) of density d=0.920 with 1-butene as comonomer, the (C1)/(C2) blend being grafted with maleic anhydride with a degree of grafting of 0.8%, and 75% by weight of LLDPE (D) with 1-butene as comonomer and d=0.910,
   Y % by weight of PP homopolymer (B) having an MFI=7 and d=0.900 and
   The value of X being indicated in the second column of TABLE 1 and the value of Y being equal to 100−X;
layer (3) having a thickness of 17 μm of PP homopolymer having an MFI=7 and d=0.900;
layer (4) having a thickness of 5 μm of propylene/ethylene/butylene terpolymer PP with predominantly propylene; MFI=7, d=0.900; and flexural modulus=1000 mPa; and
[d expressed in g/cm³ and measured according to the ASTM D790 standard at 1900 mPa and MFI or meltflow index expressed in g/10 min according to the ASTM D 1238 standard at 230° C.].

The layers (1), (3) and (4) are the same in the case of specimens 1 to 8. Only the layer (2) differs through the proportions X and Y expressed in % by weight. Sealed bags were then manufactured and peel force then measured in g/15 nm.

It was found that, in the case of compositions comprising 5 to 50% of blend (A), the layer (2) failed, as shown in FIG. 3, the Al layer being strongly bonded to the layer (2), whereas in the cases indicated by (*) the interface between the Al layer and the layer (2) failed, as illustrated in FIG. 2, the Al layer being bonded more weakly to the layer (2).

The films comprising a layer (2) with an amount of the blend (A) between 5 and 50% are therefore suitable for the manufacture of bags, sachets, pockets and packets according to the invention.

TABLE 1

| | | Peel force in | Peel force in |
|---|---|---|---|
| | % by weight of | g/15 mm, measured | g/15 mm, measured |
| | blend (A) in the | immediately after | 1 month after |
| Specimen | layer (2) | sealing | sealing |
| 8 | 0% | 50* | 30* |
| 1 | 5% | 186 | 40 |
| 2 | 10% | 198 | 80 |
| 3 | 20% | 219 | 132 |
| 4 | 30% | 212 | 180 |
| 5 | 40% | 240* | 210 |
| 6 | 50% | * | 240 |
| 7 | 100% | * | * |

*peeling of the Al film.

Trials carried out with the other metals mentioned above led to the same observations.

1: Tie comprising:
5 to 50% by weight of a blend (A), the said blend (A) comprising:
5 to 100% of a blend of polymers (C1) and (C2), consisting of 90 to 20% by weight of a metallocene polyethylene (C1) of density between 0.865 and 0.915 and of 10 to 80% by weight of a polymer (C2) which is either a non-metallocene LLDPE or a polypropylene homopolymer or copolymer, the blend of polymers (C1) and (C2) being cografted by an unsaturated carboxylic acid or a functional derivative of this acid as grafting monomer,
95 to 0% by weight of a polyethylene (D) chosen from polyethylene homopolymers or copolymers and elastomers; the blend (A) being such that:
the content of grafting monomer grafted is between 30 and 10⁵ ppm;
the MFI or meltflow index (ASTM D 1238, at 190° C./2_{—}16 kg) is between 0.1 and 30 g/10 min;
50 to 95% by weight of a polypropylene homopolymer or copolymer (B).

2: Multilayer structure comprising a layer (2) of the tie according to claim 1.

3: Multilayer structure according to claim 2, characterized in that it comprises a metal layer (1) bonded to the tie layer (2).

4: Structure according to claim 3, characterized in that the metal layer is a layer of Al, Fe, Cu, Sn. Ni, Ag, Cr or Au or an alloy containing predominantly at least one of these metals.

5: Multilayer structure according to claim 4, characterized in that it comprises a polypropylene homopolymer or copolymer layer (3), the tie layer (2) being sandwiched between the metal layer (1) and the said polypropylene layer (3).

6: Multilayer structure according to claim 5, characterized in that it comprises a layer (4) such that the polypropylene layer (3) is sandwiched between the tie layer (2) and the said layer (4), the latter layer being suitable for heat-sealing and comprising either an ethylene/propylene/butylene terpolymer, or an ethylene/propylene copolymer, or a metallocene PE or blends thereof, and in this case the said blend comprises at least two of the abovementioned compounds.

7: Film comprising a multilayer structure according to claim 2.

8: Film characterized in that it comprises a printed biaxially oriented polypropylene (BOPP) or biaxially oriented polyethylene terephthalate (BOPET) layer to which a metallized multilayer film having a structure according to claim 3 is applied by means of an adhesive, the said film being biaxially oriented or not and the metal layer of the said metallized multilayer film being directly bonded by the adhesive to the printed BOPP or BOPET layer.

9: Use of the tie according to claim 1 to manufacture a multilayer structure according to the present invention.

10: Article having a multilayer structure according to claim 2.

11: Article manufactured using a film according to claim 7.

12: Article according to claim 11, characterized in that this article is a package.
